(19) United States
(12) Patent Application Publication
(10) Pub. No.: US 2009/0060158 A1
(43) Pub. Date: Mar. 5, 2009

(54) METHOD AND SYSTEM TO DETECT A MULTI-PARTY TELEPHONE CALL

(75) Inventors: John K. Mertz, Los Gatos, CA (US); M. Brendan Philbin, Morgan Hill, CA (US)

Correspondence Address: SCHWEGMAN, LUNDBERG & WOESSNER, P.A., P.O. BOX 2938, MINNEAPOLIS, MN, 55402, US

(73) Assignee: Inmate Calling Solutions LLC d/b/a ICSolutions, San Jose, CA (US)

(21) Appl. No.: 12/199,618

(22) Filed: Aug. 27, 2008

Related U.S. Application Data
(60) Provisional application No. 60/968,647, filed on Aug. 29, 2007.

(51) Int. Cl. H04M 3/42

(52) U.S. Cl. 379/202.01

(57) ABSTRACT

A computer-implemented system to detect a multi-party telephone call, in one example embodiment, comprises a communication module to establish a telephone call to a requested telephone number, a detection module to detect an indication of a multi-party telephone call in progress, the indication being based on observing a period of silence transgressing a predetermined threshold. The system to detect a multi-party telephone call further comprises an interruption module to obtain, from a called party associated with the requested telephone number, a reference telephone number, a comparison module to compare the reference telephone number to the requested telephone number, and a terminating module to selectively terminate the telephone call based on the comparing.

### RELATED APPLICATION

This application claims the priority benefit of U.S. Provisional Application Ser. No. 60/968,647 filed Aug. 29, 2007, the content of which is incorporated herein by reference in its entirety.

### TECHNICAL FIELD

This application relates to a method and system to detect a multi-party telephone call.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

In a correctional facility environment, an inmate may be prohibited from calling a predetermined telephone number when communication between the inmate and a person associated with the predetermined telephone number is deemed undesirable. Examples of the undesirable communications may include a telephone call by the inmate to his/her criminal associate, an inmate's victim, a judge presiding in the inmate's case, or a jury member sitting in the inmate's case. The inmate, however, with some assistance, may utilize call forwarding or three-way calling features to get around the prohibition.

For example, an inmate may dial a telephone number that is not in the list of restricted telephone numbers. The recipient of the telephone call may then forward the telephone call to another telephone number that may be in a list of restricted telephone numbers, thus helping the inmate to reach a restricted telephone number. In another example, the recipient of the telephone call may initiate a three-way telephone call with a third participant who is associated with a restricted telephone number. Thus, it may be difficult to detect whether a telephone call was forwarded or whether a multi-party telephone call has been initiated.

### BRIEF DESCRIPTION OF DRAWINGS

Embodiments are illustrated by way of example and not limitation in the figures of the accompanying drawings, in which like references indicate similar elements and in which:

FIG. 1 is a block diagram showing an architecture within which a method and system to detect a multi-party telephone call are implemented, in accordance with an example embodiment;

FIG. 2 is a block diagram of a system to detect a multi-party telephone call within which an example embodiment is implemented;

FIG. 3 is a flow chart of a method to detect a multi-party telephone call, in accordance with an example embodiment;

FIG. 4 is a diagrammatic representation of an example data structure to represent a multi-party call table, in accordance with an example embodiment;

FIG. 5 is a diagrammatic representation of an example data structure to represent a multi-party call table record, in accordance with an example embodiment; and

FIG. 6 is a diagrammatic representation of an example machine in the form of a computer system within which a set of instructions for causing the machine to perform any one or more of the methodologies discussed herein are executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments may be combined, other embodiments may be utilized, or structural, logical and electrical changes may be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive or, such that “A or B” includes “A but not B.” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The example embodiments described herein may be implemented in an operating environment comprising software installed on a computer, in hardware, or in a combination of software and hardware.

The method and system to detect a multi-party telephone call are described. In an example embodiment, a workflow of the method to detect a multi-party telephone may begin in a prison environment with an inmate attempting to place a telephone call to a telephone number. Since the inmate may not be allowed to call a telephone number in the list of the restricted telephone numbers, the dialed telephone number may be verified against the existing database of the restricted telephone numbers before the telephone call is established. If the dialed telephone number is not on the list of restricted telephone numbers, the call may be established. Otherwise, the call will be terminated. Thereafter, the call will be monitored for possible multi-party telephone calls.

Multi-party telephone calls include three-way telephone calls and forwarded telephone calls. If a multi-party telephone call is suspected, the call may be interrupted to verify the identity and the telephone number associated with the called party. Once the telephone call is interrupted, the parties are provided with a pre-recorded message informing the parties of the ostensible reason for the interruption. The pre-recorded message played to the called party and the calling party may differ. The announcement to the called party may be made for the purpose of obtaining a reference telephone number associated with the called party in order to compare the reference telephone number to the called telephone number. In response, the called party should provide the reference telephone number. If the reference telephone number and the called telephone number match, the interruption is ended and the telephone call may be allowed to continue without interruptions.

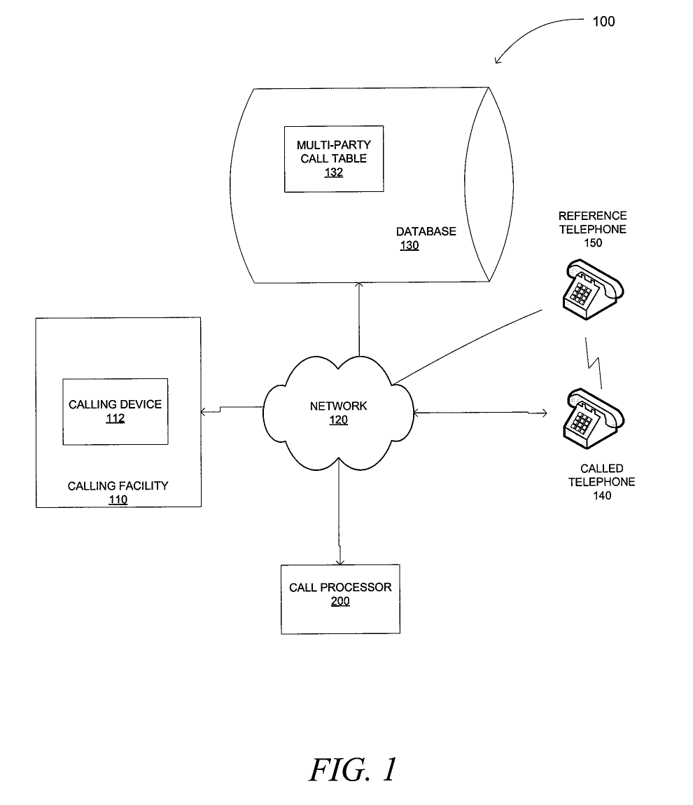

In some example embodiments, the telephone call may be allowed to continue uninterrupted notwithstanding the negative match between the called telephone number and the reference telephone number if the reference telephone number is not a telephone number from the list of the restricted telephone numbers. If, however, the reference telephone number is a telephone number from the list of the restricted telephone numbers, the telephone call may be terminated and/or the facility notified of an occurrence of a multi-party telephone call. In some example embodiments, the telephone call may be terminated and/or the facility notified of an occurrence of a multi-party telephone call even if the telephone call is forwarded to a telephone number that is not in the list of restricted telephone numbers. The system to detect a multi-party telephone call, in one example embodiment, may be utilized to detect a forwarded telephone call and a three-way telephone call. An example network environment 100 is described with reference to FIG. 1.

FIG. 1 shows the network environment 100 within which a method and system to block a telephone number may be implemented in accordance with an example embodiment. As shown in FIG. 1, a calling facility 110 may be configured to communicate with the reference telephone 150 and called telephone 140 via a network 120. A call processor 200 may reside outside of a calling facility 110 and may be utilized to detect a multi-party telephone call within the context of a network environment 100. The call processor 200 may be configured within the context of the network environment 100, where the network environment 100 comprises the calling facility 110, a calling device 112, a database 130, a multi-party call table 132, a called telephone 140, and a reference telephone 150.

Additionally, the network environment 100, in the example embodiment, may include the network 120, which may be a public network (e.g. the Internet, a wireless network, etc.) or a private network (e.g. local area network (LAN), wide area network (WAN), Intranet, etc.). The communications network 120 may be any communications environment facilitating Voice over Internet Protocol (VoIP) communications, a cellular communications network, Plain Old Telephone Service (POTS), or the like.

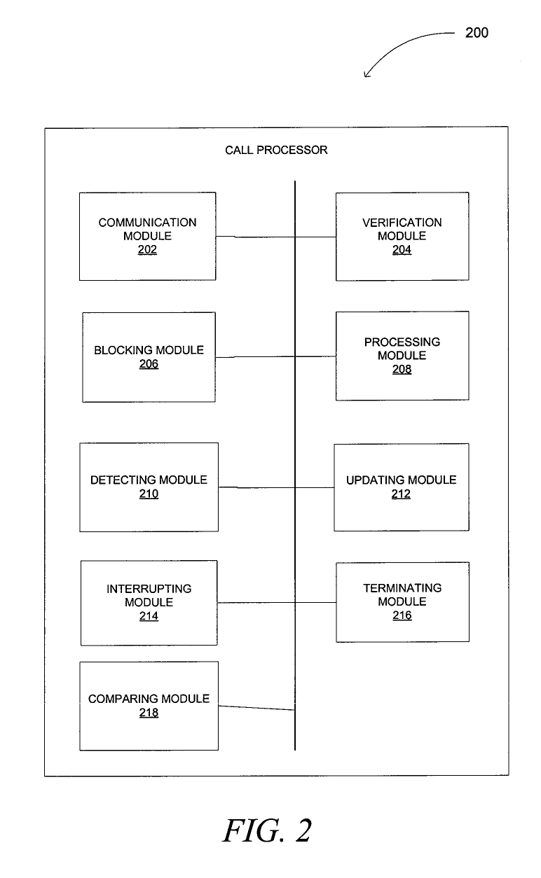

The network environment 100 may further comprise a database 130 including the multi-party call table 132. The network environment 100 may further include the calling facility 110, which may be a designated calling facility within the correctional facility. The calling device 112 illustrated within the context of the calling facility 110 may, in some example embodiments, include a conventional telephone. The calling device 112 may also be a general use computer used to facilitate VoIP communications or a wireless telephone. The network environment 100 may also include the called telephone 140, which may include a conventional telephone, VoIP, and a wireless telephone. The call processor 200 may be utilized to process the telephone calls and facilitate the execution of rules associated with an example system of this application. The call processor 200 may be a part of a bigger calling system or a stand alone system. The call processor 200 may be included in a telephone system designed to administer the telephone calls placed by inmates of the correctional facility. The administrative system may be interfaced with the call processor 200, telephone lines that are connected to the call processor 200, and the call processor 200 may control both sides of the telephone conversation. The call processor 200 is described by a way of example with reference to FIG. 2.

FIG. 2 shows a block diagram illustrating the call processor 200, in accordance with an example embodiment, configured to detect a multi-party telephone call. The example call processor 200 is shown to include several example components that may be configured to perform various operations facilitating detection of multi-party telephone calls. In some example embodiments, the call processor 200 may include the communication module 202, the verification module 204, the blocking module 206, the processing module 208, the detection module 210, the updating module 212, the interruption module 214, the terminating module 216, and the comparison module 218.

The communication module 202 may be configured to receive a request to establish a telephone call to a telephone number. Within the context of a correctional facility, an inmate, at the designated time and place, may dial a telephone number. A particular telephone number may, in some circumstances, be approved by the correctional facility or, depending on the applicable policy, may not be explicitly prohibited by the correctional facility. The verification module 204 may be configured to verify that the telephone number dialed by the inmate is not a telephone number in the list of the restricted telephone numbers. Additionally, the verification module 204 may be configured to obtain from the called party the reference telephone number and to pass the obtained information on to the comparison module 218, which compares the called telephone number to the reference telephone number.

The blocking module 206 may be configured to block the calling party, the calling device 112 or the calling facility 110 from making further calls to the same telephone number if a multi-party telephone call is attempted. Additionally, at the discretion of the correctional facility operators, the identity of the calling party or the called telephone number may be inserted into the list of unauthorized telephone numbers if is determined by the comparison module 218 that the called telephone number does not match the reference telephone number. The processing module 208 may be configured to process telephone calls and ensure that the telephone calls reach their intended destinations. The processing module 208 may be configured to maintain the telephone call connection after the telephone call is interrupted by the interruption module 214.

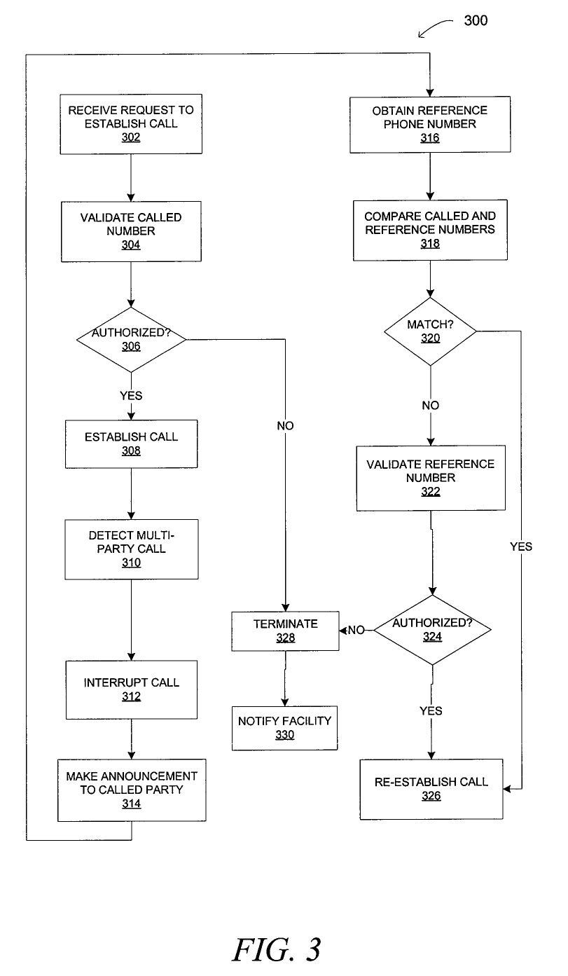

The detection module 210 may be configured to detect an indication of a multi-party telephone call in progress or it may be configured to activate when a predetermined calling party places a call or when a predetermined called telephone number is dialed. It will be noted that references to a multi-party telephone call include e.g., three-way telephone calls and forwarded telephone calls. Furthermore, the blocking module 206 may be configured to block the calling party in response to the suspicion by investigators that multiparty telephone calls may be happening. An indication of a multi-party telephone call in progress may be determined based on the observation of an extended period of silence, the extended period of silence exceeding a predetermined threshold. The method for detecting a multi-party telephone call is explained by way of example, with reference to FIG. 3.

Returning to FIG. 2, the updating module 212 may be configured to update the database 130 with new data obtained as a result of detecting a multi-party telephone call. The updating module 212 may, in some example embodiments, change the values of the multi-party call table 132. The values updated may include the identity of the party placing the telephone call, the called telephone number, the telephone number associated with the reference telephone 150, the monitoring mode, the DNR (Do Not Record) flag, the restriction flag, and the terminating flag.

The interruption module 214 may be configured to interrupt the telephone call in response to detecting an indication of a multi-party telephone call by the detection module 210 and obtain, from a party associated with the called telephone 140, a telephone number associated with the reference telephone 150. The interruption module 214 may provide another announcement informing the calling party that the telephone call is being interrupted for technical reasons. The interruption module 214 may further provide another announcement requesting the called party to provide the reference telephone number. Thereafter, the information received may be used by the comparison module 218 to determine whether the called telephone number matches the reference telephone number obtained from the called party. The interruption module 214 may be configured to terminate the telephone conversation between the calling party and the called party based on a predetermined business rule, as explained below by way of example.

The terminating module 216 may be configured to terminate the telephone call to the called telephone number in response to a determination by the comparison module 218 that the reference telephone number and the called telephone number do not match and therefore a multi-party telephone call may be in progress. The terminating module 216 may also be configured to terminate the telephone call in response to the determination by the verification module 204 that the called telephone number is not authorized to be called by the calling party.

The comparison module 218 may be configured to compare the reference telephone number to the called telephone number. If the telephone number associated with the reference telephone 150 matches the telephone number associated with the called telephone 140, the telephone call is allowed to be continued uninterrupted. Otherwise, the telephone call may be terminated by the terminating module 216 based upon the configuration selected by the calling facility 110. Various operations performed by the call processor 200, according to an example embodiment, are described by way of example with reference to FIG. 3.

FIG. 3 is a flow chart illustrating a method 300 to detect a multi-party telephone call, in accordance with an example embodiment. The method 300 may be performed by processing logic (e.g. dedicated logic, programmable logic, microcode, etc.) that may comprise hardware, software (such as that run on a general purpose computer system or a dedicated machine), or a combination of both. In one example embodiment, the method 300 may be performed by the various modules discussed above with reference to FIG. 2. Each of these modules may comprise processing logic.

As shown in FIG. 3, the method 300 may commence at operation 302 with the communication module 202 from FIG. 2 receiving a request to establish a telephone call to the called device 140. The calling device 112 may be located in the calling facility 110 and configured to require a PIN (Personal Identification Number). An inmate wishing to make a telephone call may access a calling device 112 (e.g. telephone). There, the inmate may be asked to enter the PIN identifying himself to the calling facility 110. The calling facility 110 may then ask the inmate to provide the called telephone number. The telephone call may be established after the verification is made that the called telephone number 140 is authorized. An announcement to the called party associated with the called telephone number 140 may be made informing the called party that they have a call from the inmate of the correctional facility. As a part of the verification process, a positive identification of the inmate and acceptance by the called party may be required. The acceptance by the called party may be effected by requiring the called party to press a telephone key indicating acceptance.

Returning to FIG. 3, at operation 304, the verification module 204 may verify that the telephone number associated with the called telephone 140 is authorized. Depending on local policies, the telephone call may be successfully established if the called telephone number is pre-authorized by the correctional facility or if the called telephone number is not in the list of the restricted telephone numbers. Accordingly, based on the called telephone number and the inmate record, at operation 306 the decision is made as to whether or not the inmate may make telephone calls in general, and as to whether the inmate may make the telephone call to the called telephone 140, in particular. If it is determined that the called telephone number is authorized and that the inmate is authorized to make the telephone call to the called telephone 140, a telephone call may be established at operation 308. In some example embodiments, the call processor 200 may restrict the inmate using pre-determined station groups and only allow the inmate to make telephone calls from predetermined locations. The call processor 200 operators may set up personal access numbers for inmates to satisfy local policy requirements. For example, the State of Wyoming only allows inmates to call telephone numbers that have been authorized by the State of Wyoming. Accordingly, the inmate may only call the telephone numbers from the list of the authorized telephone numbers.

In some example embodiments, a correctional facility policy may prevent the inmate from calling a telephone number by inserting the telephone number into the list of the restricted telephone numbers. In some example embodiments, every inmate from the same facility may be prevented from calling a telephone number from the list of the restricted telephone numbers. In some example embodiments, certain inmates from a particular facility may be allowed to call a telephone number while other inmates at that same facility may not be allowed to call the telephone number. In some example embodiments, there may be a predetermined list of the restricted telephone numbers, wherein the telephone numbers are compiled from previous attempts to establish multi-party telephone calls.

In some example embodiments, a telephone number from the list of the restricted telephone numbers may be authorized at the discretion of the correctional facility. In some example embodiments, global telephone numbers, such as attorney telephone numbers, may be utilized. Attorney telephone numbers may be assigned a true DNR (Do Not Record) value. Accordingly, an attorney telephone number may not be recorded but the telephone call between the attorney and an inmate may still be interrupted to establish the reference telephone number and determine if a multiparty telephone call is being attempted. In some example embodiments, alerts may be set up, so that if a predetermined telephone number is called and the telephone call is accepted, an alert, either by page, email or telephone call, is sent to the correctional facility personnel to trigger a monitoring procedure, e.g., to inform an investigator that a telephone call may need to be monitored.

At decision block 306, it is determined whether or not the telephone call to the called telephone 140 is authorized. If, at decision block 306, it is determined that the telephone call to the called telephone 140 is not authorized, e.g., for one or more of the reasons mentioned above, the telephone call will be terminated at operation 328. If, on the contrary, it is determined at decision block 306 that the telephone call to the called telephone 140 is authorized, the telephone call will be established at operation 308.

At operation 308, the telephone call may be established and possibly monitored. In some example embodiments the monitoring may be performed manually by listening to the telephone conversation between the calling party and the called party. In some example embodiments, the monitoring may be automated. In some example embodiments, the monitoring may be automated with the events triggering the monitoring being predetermined e.g., the inmate is classified as a drug dealer or the called telephone number is associated with a drug dealer. Thus, the decision to monitor a telephone call may be made automatically or by a human decision based on the identity of the inmate or the called telephone number. Once the telephone call is established, the calling party and the called party may communicate for a period of time. In one example embodiment, the permitted length of communication with a called party may be preset by the correctional facility operators as the maximum duration of the conversation.

At operation 310, a multi-party telephone call may be detected by the detection module 210. In some example embodiments, the detection of a three-way telephone call may be made by the detection module 210 observing a period of silence exceeding a predetermined threshold. A period of silence exceeding the predetermined threshold may be indicative of the called party dialing a telephone number of a third party in order to establish a communication between the calling party and the third party. In some example embodiments, the decision as to whether to activate the detection may be made based on the identity of the calling party, based on the identity of the called party, or based on the origin of the telephone call. In some example embodiments, the decision as to whether to activate the detection may be random or based on the calling party being associated with a predetermined correctional facility. In some example embodiments, the detection may be activated for a group of telephones for a specific length of time or for a predetermined called telephone number for a predetermined length of time.

In some example embodiments, the detection of a multi-party telephone call may be turned on when the detection module 210 detects an occurrence of a triggering event. Where the multi-party telephone call is a three-way telephone call, the detection may be based on a determination as to whether a telephone call has been interrupted or another telephone call is placed to connect the two telephones to a third telephone. In some example embodiments, at operation 310, the detection module 210 listens for silence for a period of a predetermined duration. The silence may be treated as an indication that a three-way call is in progress. The silence, however, may be just an indication of a possible three-way call. As an example, the reason for an extended period of silence may be that a person associated with the called telephone 140 is getting somebody else to talk to the calling party via the called telephone 140.

It will be noted that other methods of detecting a potential three-way or call forward events may be used. An indication of a possible multi-party telephone call may trigger a further investigation into the reasons for the silence. In some example embodiments the investigation is triggered without a detection of the extended period of silence if there are other indications making the inmate, the calling device 112, or the called telephone 140 suspects. Such an indication may be included in information obtained outside the scope of the system and method described herein informing the correctional facility operators that the inmate may attempt to establish a multi-party telephone call.

At operation 312, the telephone call established at operation 308 may be interrupted by the interruption module 214 in order to investigate the telephone call. The call processor 200 may set a flag so that every telephone call is monitored periodically and randomly throughout the telephone call. If a decision is reached to interrupt the telephone call, at operation 312 the telephone call may be interrupted and, at operation 314, an announcement may be made to the called party informing the party that the telephone call is interrupted for a verification of the reference telephone number. The called party may be asked to enter the reference telephone number by using the telephone keypad. Accordingly, at operation 312, the established telephone call is interrupted and, at operation 316, the called party is asked to provide a reference telephone number. The information received from the called party is saved to the database 130 by the updating module 212.

At operation 312 the interruption module 214 interrupts the telephone call based on the detection, at operation 310, by the detection module 210 of an indication of a multi-party call in progress, triggering an investigative mode. At operation 312, in response to the detected silence and after the system switches to the investigative mode, the interruption module 214 may interrupt the telephone call. Thereafter, an announcement may be made to the calling party without the inmate hearing the announcement. The announcement made to the calling party may request the calling party to wait until the calling party's account is being validated. In some example embodiments, both parties may hear the announcement made to the calling party. An example announcement may sound as follows: “Please wait until your account is validated.”

At operation 316, the interruption module 214 obtains the reference telephone number from the called party. In some example embodiments the announcement may be completely automated, with a pre-recorded message asking the called party to enter the reference telephone number using the telephone keypad. In some example embodiments a human operator may ask the calling party to enter the reference telephone number using the telephone keypad or state the telephone number orally. An example announcement may sound as follows: “Please state your telephone number for verification purposes.” In some example embodiments, the name of the party associated with the reference telephone number may be obtained. In some example embodiments, instead of a 10-digit reference telephone number, the called party may be asked to enter the last four digits of the reference telephone number.

At operation 318, the comparison module 218 may compare the called telephone number to the reference telephone number to determine whether or not the called telephone number matches the reference telephone number. In some example embodiments, if the reference telephone number does not match the called telephone number, the party associated with the reference telephone 150 may be provided with a predetermined telephone number of attempts to enter the correct reference telephone number in the event that an incorrect telephone number is entered in error. At operation 320, the comparison module 218 may determine whether or not the called telephone number and reference telephone number match.

If it is determined at operation 320 that the called telephone number matches the reference telephone number, the telephone call is re-established at operation 326. If, on the contrary, it is determined at operation 320 that the called telephone number and the reference telephone number do no not match, the telephone call is not re-established between the calling device 112 and the called telephone 140 and may be terminated at operation 328 by the terminating module 216. In some example embodiments the correctional facility may be notified about the terminated call at operation 330 and the database 130 may be updated by the updating module 212. In some example embodiments, the telephone call may not be terminated in response to the determination at operation 320 of a negative match between the called telephone number and the reference telephone number. Instead, the reference telephone number may be validated by the verification module 204 at operation 322 to ensure that the reference telephone number is not in the list of restricted telephone numbers.

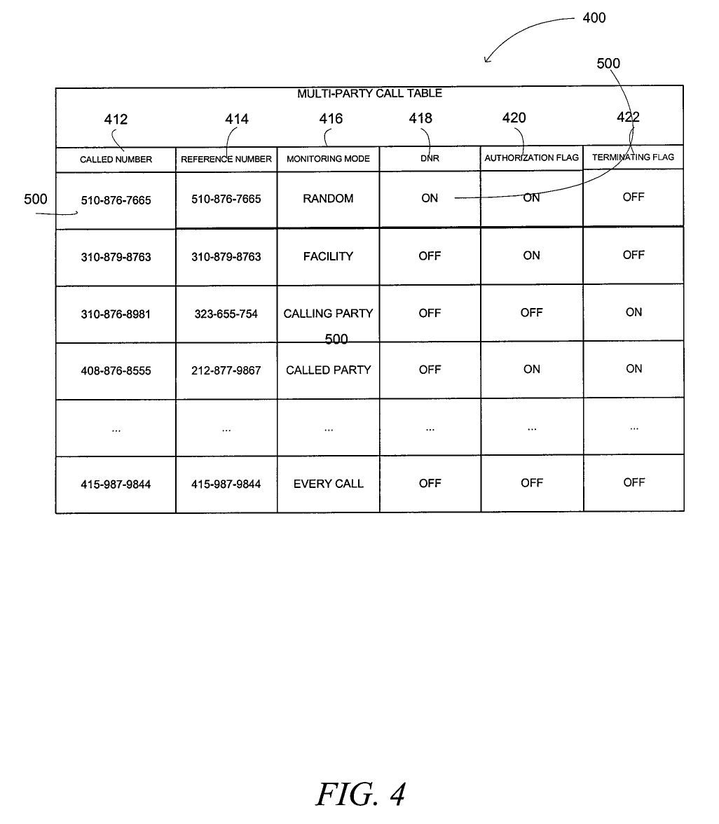

If it is determined, at operation 324, that the reference telephone number is an authorized telephone number, the telephone call may be re-established at operation 326. If the reference telephone number is not an authorized telephone number, the telephone call may still be allowed to continue for investigative purposes. In such case, the telephone call may be flagged in the database 130 for future review by the correctional facility operators. In some example embodiments, the correctional facility operators may be notified of the terminated telephone call at operation 330. The data associated with the multi-party telephone call will be stored in the database 130 and may be flagged as a terminated telephone call. The notification of the correctional facility in operation 330 may include alerting the facility by email, page, or telephone if requested. Additionally, the telephone number associated with the called telephone 140 and the telephone numbers associated with the reference telephone number may be blocked and inserted into the list of restricted telephone numbers, and the database 130 may be updated accordingly. A table to store multi-party call records is described with reference to FIG. 4.

FIG. 4 illustrates a possible multi-party call table 132 comprising a plurality of multi-party call records 500. The multi-party call records 500, may, in some example embodiments, comprise the called number field 412, the reference number field 414, the monitoring mode field 416, the DNR field 418, the authorization flag field 420, and the terminating flag field 422.

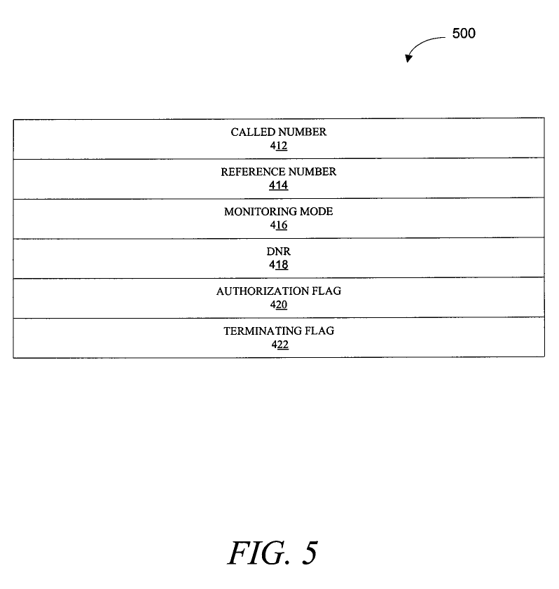

As shown in FIG. 5, the called number field 412 is comprised of a list of telephone numbers originally dialed by the inmate to establish a telephone call. Initially, the called telephone number is checked for validity. For example, when there is an indication of a multi-party telephone call, the called telephone number may be checked to determine whether the reference telephone number and the called telephone number match. If there is no match, the telephone call may be terminated, the called telephone number blocked and added to the list of restricted telephone numbers. The reference number field 414 is comprised of the telephone numbers that are obtained from the called parties. The reference telephone number may be the telephone number forwarded to by the called party in case of a forwarded telephone. In the case of a three-way call the reference telephone number is the telephone number associated with the third party brought online by the called. The reference telephone number may be blocked or inserted in the list of restricted telephone numbers in the event that the telephone call is terminated in response to a multi-party telephone call. In some example embodiments, the telephone call may not be terminated in response to a multi-party telephone call. Instead, the reference telephone number is verified against the list of the restricted telephone numbers to determine whether or not the reference telephone number is a permitted telephone number. If it is determined that the reference telephone number is a permitted telephone number, the telephone call is re-established notwithstanding the determination of a multi-party telephone call.

The monitoring mode field 416, in one example embodiment, includes a Boolean value that may be represented by either true or false (e.g., 1 or 0). The monitoring mode field 416 is set to true when the system detects a multi-party telephone call is operating in an investigative mode. As discussed above, the investigative mode may be set manually or automatically. The DNR field 418 contains a Boolean value that may be represented by either true or false. The DNR field 418 may be set to true when, for example, the called telephone is associated with an attorney representing an inmate. In some example embodiments, a DNR value set to true may be an indication that no investigative mode may be set for the telephone call.

The authorization flag field 420 is a Boolean field that may be set to true if the telephone number is authorized and set to false if the telephone number is not authorized. Thus, if the telephone number is associated with a multi-party telephone call, the authorization flag field 420 may be set to false. When the authorization flag field 420 is set to false, the verification of the telephone number may fail and the telephone call may be terminated. The terminating flag field 422 is set to true when the telephone call is terminated. As mentioned above, the multi-party call records 500 in the multi-party call table 132 may be updated in response to the detection of a multi-party telephone call.

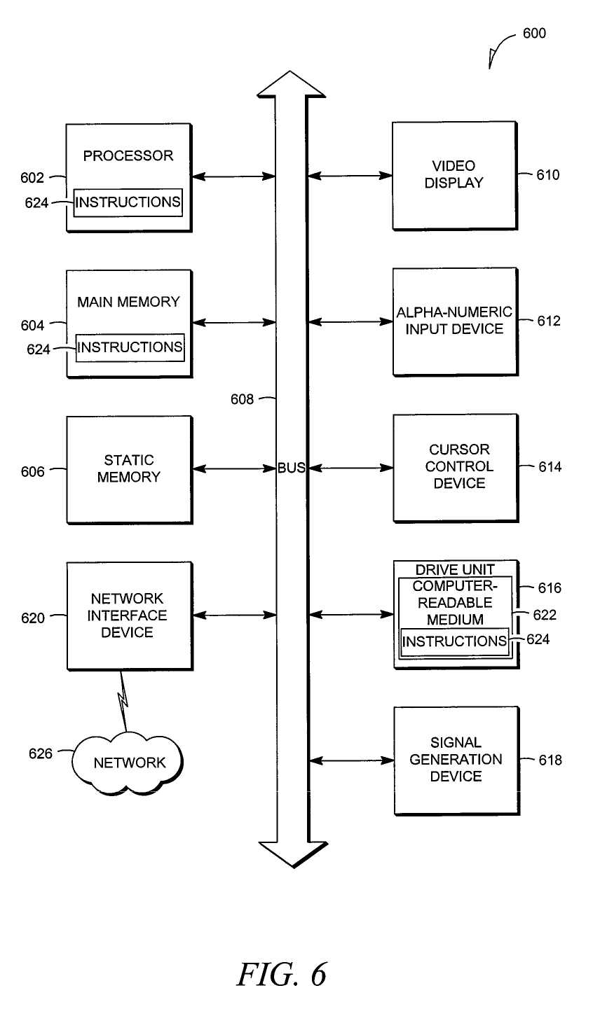

FIG. 6 shows a diagrammatic representation of a machine in the example electronic form of a computer system 600 within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an MP3 player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), and a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation device 614 (e.g., a mouse), a disk drive unit 616, a signal generation device 618 (e.g., a speaker) and a network interface device 620.

The disk drive unit 616 includes a computer-readable medium 622 on which is stored one or more sets of instructions and data structures (e.g., instructions 624) embodying or utilized by any one or more of the methodologies or functions described herein. The instructions 624 may also reside, completely or at least partially, within the main memory 604 and/or within the processor 602 during execution thereof by the computer system 600. The main memory 604 and the processor 602 also constitute machine-readable media.

The instructions 624 may further be transmitted or received over a network 626 via the network interface device 620 utilizing any one of a number of well-known communication protocols (e.g., Transmission Control Protocol (TCP), User Datagram Protocol (UDP) or Hyper Text Transfer Protocol (HTTP)).

While the computer-readable medium 622 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that causes the machine to perform any one or more of the methodologies of the present application, or that is capable of storing, encoding or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The example embodiments described herein may be implemented in an operating environment comprising software installed on a computer or on a plurality of networked computers, in hardware, or in a combination of software and hardware.

Thus, a method and system to detect multi-party telephone calls have been described. Although embodiments have been described with reference to specific example embodiments, it will be evident that various modifications and changes may be made to these example embodiments without departing from the broader spirit and scope of the present application. Accordingly, the specification and drawings are to be regarded in an illustrative rather than a restrictive sense.

1. A computer-implemented method comprising:
establishing a telephone call to a requested telephone number;
detecting an indication of a multi-party telephone call in progress, the indication being based on observing a period of silence, the period of silence exceeding a predetermined threshold;
interrupting the telephone call to obtain, from a called party associated with the requested telephone number, a reference telephone number;
comparing the reference telephone number to the requested telephone number; and
selectively terminating the telephone call based on the comparison.

2. The computer-implemented method of claim 1, wherein the multi-party telephone call is a forwarded telephone call.

3. The computer-implemented method of claim 1, wherein the multi-party telephone call is a three-way telephone call.

4. The computer-implemented method of claim 1, comprising restricting access to the reference telephone number by a calling party.

5. The computer-implemented method of claim 1, wherein the detecting is performed in response to the telephone call placed to a predetermined telephone number.

6. The computer-implemented method of claim 1, wherein the detecting is in response to determining the identity of a calling party.

7. The computer-implemented method of claim 1, wherein the detecting is in response to determining that a calling party is associated with a predetermined correctional facility.

8. The computer-implemented method of claim 1, wherein the detecting is in response to a predetermined detection operation based upon one or more of predetermined criterion.

9. The computer-implemented method of claim 1, wherein the interrupting of the telephone call to obtain the reference telephone number is accompanied by providing an audio request to a recipient associated with the requested telephone call.

10. A computer-implemented system comprising:
a communication module to establish a telephone call to a requested telephone number;
a detection module to detect an indication of a multi-party telephone call in progress, the indication being based on observing a period of silence exceeding a predetermined threshold;
an interruption module to obtain, from a called party associated with the requested telephone number, a reference telephone number;
a comparison module to compare the reference telephone number to the requested telephone number; and
a termination module to selectively terminate the telephone call in response to the comparison.

11. The computer-implemented system of claim 10, wherein the multi-party telephone call is a forwarded telephone call.

12. The computer-implemented system of claim 10, wherein the multi-party telephone call is a three-way telephone call.

13. The computer-implemented system of claim 10, wherein the terminating module is configured to terminate the telephone call when a calling party is associated with a predetermined telephone number.

14. The computer-implemented system of claim 10, wherein the detection module is configured to detect the indication of the multi-party telephone call in response to determining that the requested telephone number is a predetermined telephone number.

15. The computer-implemented system of claim 10, wherein the detection module is configured to detect the indication of the multi-party telephone call in progress based on an identity of a calling party associated with the telephone call.

16. The computer-implemented system of claim 10, wherein the detection module is configured to detect the indication of the multi-party telephone call in progress in response to determining that a calling party is associated with a correctional facility.

17. The computer-implemented system of claim 10, wherein the interruption module is configured to provide an audio request to a recipient associated with the requested telephone call.

18. A computer-readable medium comprising instructions, which, when implemented by one or more processors, perform the following operations:
establish a telephone call to a requested telephone number;
detect an indication of a multi-party telephone call in progress, the indication being based on observing a period of silence transgressing a predetermined threshold;
interrupt the telephone call to obtain, from a called party associated with the requested telephone number, a reference telephone number;
compare the reference telephone number to the requested telephone number; and
selectively terminate the telephone call in response to the comparison.

19. A computer-implemented method comprising:
means for establishing a telephone call to a requested telephone number;
means for detecting an indication of a multi-party telephone call in progress,
the indication being based on observing a period of silence exceeding a predetermined threshold;
means for interrupting the telephone call to obtain, from a called party associated with the requested telephone number, a reference telephone number;
means for comparing the reference telephone number to the requested telephone number; and
means for selectively terminating the telephone call based on the comparison.
